(19) United States
(12) Patent Application Publication
(10) Pub. No.: US 2008/0091613 A1
(43) Pub. Date: Apr. 17, 2008

(54) RIGHTS MANAGEMENT IN A CLOUD

(75) Inventors: William H. Gates, Medina, WA (US); Ira L. Snyder, Bellevue, WA (US); Thomas F. Bergstraesser, Kirkland, WA (US); Arnold N. Blinn, Hunts Point, WA (US); William J. Bolosky, Issaquah, WA (US); Christopher W. Brumme, Mercer Island, WA (US); Lili Cheng, Bellevue, WA (US); Dane A. Glasgow, Medina, WA (US); Daniel S. Glasser, Mercer Island, WA (US); Alexander G. Gounares, Kirkland, WA (US); James R. Larus, Mercer Island, WA (US); Matthew B. MacLaurin, Woodinville, WA (US); Henricus Johannes Maria Meijer, Mercer Island, WA (US); Debi P. Mishra, Bellevue, WA (US); Amit Mital, Kirkland, WA (US); Kartik N. Raghavan, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/536,598

(22) Filed: Sep. 28, 2006

(51) Int. Cl. H04L 9/00

(52) U.S. Cl. 705/59

(57) ABSTRACT

Innovative aspects provided herein pertain to digital rights management (DRM) and/or enforcement in conjunction with remote network clouds and services. Digital rights management licenses/rights/policies can be applied to personal files to facilitate worry free remote storage and/or file sharing. These rights can be identity-centric rather than machine centric, thereby facilitating access and usage from any network device anywhere. Various mechanisms are also disclosed to deter assorted uses of content and/or encourage rights acquisition as an alterative or in addition to technologically prohibitive means. Additionally, a system and method are provided that can afford a frictionless marketplace for file distribution, wherein content is protected and freely distributed and identity-centric rights can be purchased to access the content.

### BACKGROUND

Digital rights management (DRM) refers to a collection of technologies that control access to digital content and administer usage restrictions. DRM is employed by content owners such as the entertainment industry to protect and control use of copyrighted material. Security features associated with protected content can be unlocked after agreements have been made regarding the use of such content and likely payment of a fee. One of the more common DRM technologies utilizes cryptography. Content can be protected or locked via encryption. The same content can be unlocked or decrypted with a key provided by the content owner upon satisfaction of one or more conditions.

User applications are charged with the burden of managing finer grain usage restrictions. Content owners may allow a user to access content but with restrictions on how the content can be employed. For instance, the content may be accessed only a certain number of times or for a particular time period. Other restrictions can pertain to printing, copying, transferring, hardcopy generation, modification and the like. These restrictions can be associated with files as metadata for example as license terms. Upon access of a file, the executing application can check the license terms and manage functionality to ensure compliance.

Consider for example, the functionality of a conventional music download system. As is typical, DRM is employed to protect the copyrights of a large commercial entity, namely the music industry and members thereof. Utilizing particular software such as a media player, users can locate music tracks of interest by viewing track information and listening to a short snippet. If a user wishes to gain rights to the entire track, they must register the music service by providing a user name and password as well as a payment means. Upon receipt of payment, an encrypted copy of the track including embedded licensing terms can be downloaded from the service to the user hardware device (e.g., personal computer (PC)). To listen to the downloaded track, the user simply instructs a media player to being playing the track. Behind the scenes, the media player contacts the music service and identifies the track to be played. In return, a key is provided by the service to the media player that can be utilized to decrypt and ultimately play the track. In addition to playing the track, the media player also includes mechanisms to enforce other restrictions identified in metadata associated with the track. For example, the media player can prevent burning the track to disk or saving to another device.

It is to be noted that the exemplary and like conventional systems are device-centric. Such systems often require information to uniquely identify hardware devices utilized to interact with downloaded content. This information is then employed to control which devices will be provided with keys to decrypt downloaded files. For example, a system may allow a user to interact with files only on a small number of designated devices. When a key is requested to decrypt a file, hardware identifying information is also passed and is compared to stored service data. If the information matches information, a key is transmitted. If there is no match, the user can add the new hardware as an authorized device and then receive the key. However, if the new device exceeds the designated number, the user will not be able to access the key and utilize the file on the device without deleting another device and adding the new device, if allowed at all.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure relates to rights management and/or enforcement in a cloud. Content protection is administered as a cloud service. More particularly, content can be protected remotely and keys distributed on-demand to authenticated individuals to unlock content. Moreover, the system is identity-centric rather than device-centric. Identity can be authenticated by comparing initial user and/or third-party information with provided information such that identity can be validated with a high confidence. As a result, users with rights can access protected content from any network device anywhere.

In accordance with one aspect of the disclosure, a system is provided to support personal digital rights management. Users can apply access and/or usage restrictions to personal files typically stored on a personal computer and/or mobile device. In this manner, content can be persisted remotely and/or transmitted to others without concern of misuse, at least because only individuals designated rights can access and use the content.

According to another aspect of the disclosure, automated mechanisms are presented that protect content by urging users not to utilized unlicensed software and/or encouraging licensing thereof. More specifically, psychological means can be employed to persuade users to utilize content for which they have rights, for instance by appealing to their conscience, influencing a measure of user reputation and/or supplying incentives.

In accordance with yet another aspect, rights management systems and methods are designed to provide a frictionless marketplace for content distribution. Content can be protected and subsequently allowed to be freely distributed, for instance via downloading, copying, linking transmitting, etc. Users who desire to access and/or utilize content can purchase license rights. Payment can be collected and fees distributed to content owners. Further, license rights can be linked to a user's identity and keys provided on-demand to authenticated identities that enable access to protected content.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a rights management system.

FIG. 2 is a block diagram of a representative identity component.

FIG. 3 is a block diagram of a representative protection component.

FIG. 4 is a block diagram of a representative influence component.

FIG. 5 is a block diagram of a rights system that supports a frictionless marketplace for content distribution.

FIG. 6 is a block diagram of a system that facilitates interaction with a rights management service.

FIG. 7 is a flow chart diagram of a method of authenticating user identity.

FIG. 8 is a flow chart diagram of a method of urging users to obtain content rights.

FIG. 9 is a flow chart diagram of a method of employing rights management with respect to personal content.

FIG. 10 is a flow chart diagram of a method of commercial distribution of content.

FIG. 11 is a schematic block diagram illustrating a suitable operating environment for aspects of the subject innovation.

FIG. 12 is a schematic block diagram of a sample-computing environment.

### DETAILED DESCRIPTION

Provided herein are systems and methods pertaining to digital rights management and/or enforcement thereof. According to an aspect, such systems and methods can be identity-centric rather than device centric. As a result, users are able to seamlessly access content for which they have rights from any device anywhere. Further, rather than or in addition to DRM technologies such as those that employ encryption, mechanisms are provided to support application of psychological pressure to users to conform to desired access and/or usage restrictions and/or acquire rights. Additionally, mechanisms are provided to support personal rights management whereby users can protect individual and/or personal content such as that stored remotely (e.g., in cloud) and/or transmitted to or accessible by others. Still further yet, rights management can be employed to afford a frictionless marketplace for content distribution.

Various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

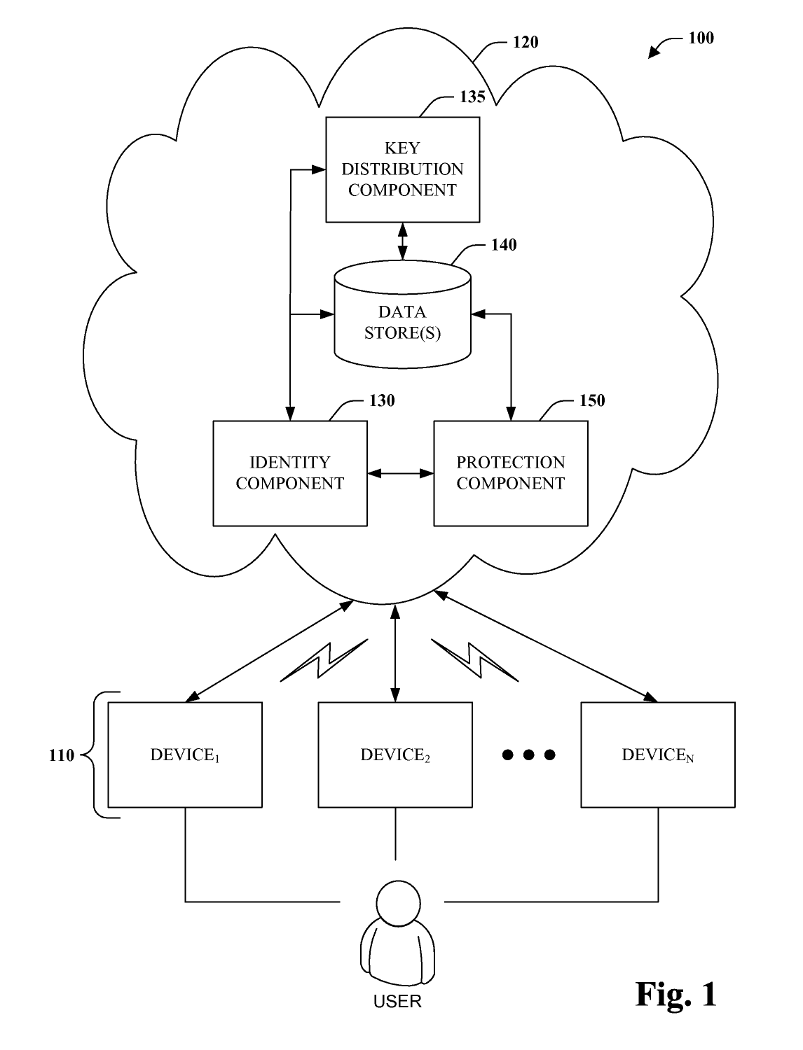

Referring initially to FIG. 1, a rights management system 100 is depicted in accordance with an aspect of this disclosure. A user may attempt to access electronically stored or computer readable content (e.g., data, files, items, media, executables . . . ) utilizing at least one device 110 (DEVICE₁, DEVICE₂ . . . DEVICE_{N}, where N is an integer greater than or equal to one). Devices 110 can correspond to computers or other types of computing hardware. For example, a user can employ a personal computer (PC), mobile phone, personal digital assistant (PDA), music jukebox, set-top box, vehicle computer and/or public computer terminal to access content, among other things. Such content can be local to the device or remotely located. Moreover, the content can be protected from unauthorized access and/or usage.

Content and/or rights thereto can be provisioned, managed and/or enforced remotely utilizing one or more cloud services and/or components thereof. As defined herein, a cloud is comprised of a collection of network accessible hardware and/or software resources. These resources are likely remote to a user unless of course the user is associated with affording such services. Assuming a user is in possession of protected content for which they have particular rights, cloud service 120 can be contacted to facilitate access and/or use of such content by a user regardless of the device 110 currently employed thereby. Similarly, a user can locate protected content anywhere in the cloud or elsewhere for which they have rights and gain access to, and use of, the content in accordance with the user's rights. Still further yet, the cloud service 120 can be utilized by a user to obtain rights to protected content.

The cloud service 120 includes several components that provide particular functionality. Identity component 130 is a mechanism that establishes and validates or authenticates a user's identity. This can be accomplished by storing and retrieving identification data to and from data store(s) 140. Protection component 150 provides varying degrees of security/access control with respect to content based at least in part on a user identity provided by identity component 130. Protection component 150 can also utilize data store(s) 140 to, among other things, store data including but not limited to user rights/licenses, protected content, and keys. Once an identity is established, rights can be associated with a particular individual or associated identity, rather than a device as is the convention. Key distribution component 135 can be utilized to distribute keys to authenticated individuals with rights on demand, which can be employed to remove protection in accordance with rights granted. Accordingly, rights can be utilized anywhere by a validated individual.

Consider an exemplary scenario where a user has a license to play a particular protected song. As will be described further infra, the license can be obtained, for instance, from numerous sources (including the service 120) and reported to the protection component 150 and/or data store(s) 140 associated therewith. The user can then obtain the protected song via any one of a plurality of means. For instance, the user can acquire the song from another user over an anonymous ad-hoc network or a friend's webpage or space. What is being distributed is a protected version of the song rather than an unprotected copy. Accordingly, to play the song on any device 110 (e.g., public computer), a key held by the protection component 150 can be provided to unlock the song. To obtain the key, the user's identity needs to be authenticated by identity component 150. Once validated, key distribution component 135 can determine that the user has a license to play the song and send the key to the device to enable the song to be played. As a result, a user will be able to access and utilize content for which they have rights from anywhere via substantially any network computing device.

By way of example, a first user may obtain rights to play a song from their personal computer and subsequently employ those rights to play the song on a friend's computer or any number of personal devices. The key is afforded and employable based on an authenticated/authorized identity with rights not the device being utilized. It should also be noted that the duration of key usage can be limited such that authentication need not occur each time a user desires to access restricted content. In other words, once authenticated a user may have rights to play a song for a limited period of time after which the key expires and is no longer available to unlock content. At this point, a user can then re-authenticate and receive another key. Further yet, mechanism can be employed to warn users if they attempt to purchase rights that they already own and/or determine rights associated therewith, as will be described further infra.

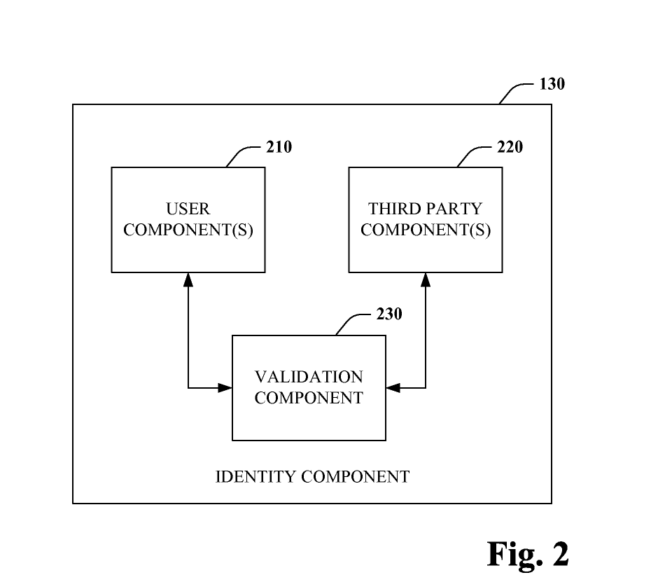

FIG. 2 depicts a representative identifier component 130 in accordance with an aspect of the disclosure. The identifier component 130 facilitates unique identification of users. User component 210 provides a mechanism for authenticating a user by comparing user provided information. For instance, a user name and pass code can be provided, which are compared to authenticate a user. However, this may not enable a user to be identified with a great degree of confidence at least because such information can be easily shared amongst a plurality of users or hacked. Such a consequence can cause problems with respect to a purely identity based rights system. Accordingly, other mechanisms can be utilized by user component 210 alone or in conjunction with user name and pass code such as biometrics. Biometrics pertain to one or more measures of user physical and/or behavioral characteristics. For example, fingerprint, handprint, iris pattern, signature, and/or typing pattern, among others, can be utilized. Once initially gathered, stored biometric information can be compared with provided biometric information to authenticate a user with a greater degree of confidence. For instance, fingerprint data as well as a pass code can be gathered and compared to authenticate a user.

The identifier component 130 also includes a third party component 220 to aid in identifying individuals. While the user component 130 relies more on self-certification techniques, the third party component 220 relies on others to aid identification. For example, the third party component 220 can facilitate communication with a certification organization that will verify that a user is who they claim to be based on some shared secret. These certification organizations can utilize some of the same techniques provided supra such as user name and password and/or biometric authentications. However, they can also utilize different means such as smart cards, credit cards, id cards and or the like. For instance, a card scanner can be built into a device keyboard to enable a user to scan their credit card. The credit card company can then validate a user's identity. Further yet, identity can be authenticated based on what others associated with that identity such as their reputation usage patterns and the like. Additional and/or alternative means or mechanisms can be utilized based on user actions or interactions with third parties.

Also included within the identity component 130 is validation component 230. The validation component 230 aggregates data from various sources including the user component 210 and the third party component 220 to determine whether a user should be validated or authenticated. This determination can be made based on the received or retrieved information as well as a level of trustworthiness associated with such information. Accordingly, if an third party organization with a high level of trust authenticates a user, the user may be validated based solely thereon. However, if an organization with a lower trust level authenticates a user then more information may need to be gathered to corroborate the authentication. An identity can be validated or authenticated by the validation component 230 based on a threshold level of trustworthiness. In this manner, it will be more difficult, if not impossible, to steal someone's identity and utilize rights associated with that identity.

It should be appreciated that authentication or authentication/authorization can imply more than the ability to identify an individual with a high degree of certainty. If this were solely the case then any authenticated identity could access any content, which is not necessarily true. The authenticated identity must also be authorized to access particular content. Thus, rights are associated with particular authenticated identities. In other words, the authenticated identities are authorized to access content.

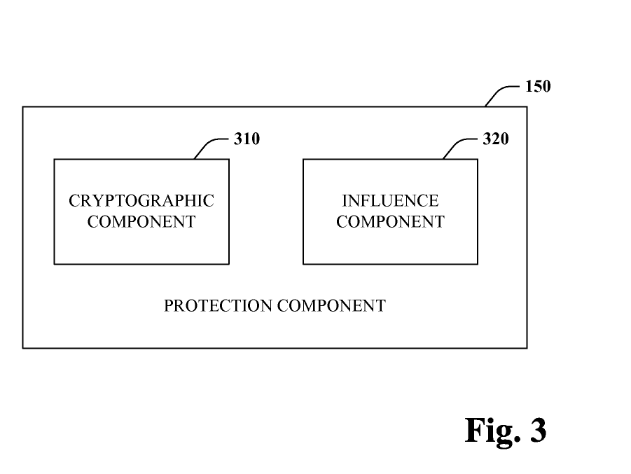

FIG. 3 illustrates a representative protection component 150 in accordance with an aspect of the subject disclosure. The component 150 can employ various mechanisms to protect content. In particular, cryptographic component 310 can be employed to encrypt and decrypt content or portions thereof to control access and use. For example, encrypted content can be obtained in a myriad of different ways. However, in order to access such content a cryptographic key may be needed to unlock the protected content via decryption. Hence, encrypted content can be easily obtained, but access to the key controlled based on identity, for instance. Other protection mechanisms can be employed alone or in conjunction with cryptography.

The protection component 150 also includes an influence component 320. Influence component 320 attempts to influence or persuade users to acquire rights associated with particular digital content. Rather than attempting to limit access to content to individuals with proper rights, the influence component 320 can sway users toward obtaining rights by appealing to their conscience and/or reputation, inter alia.

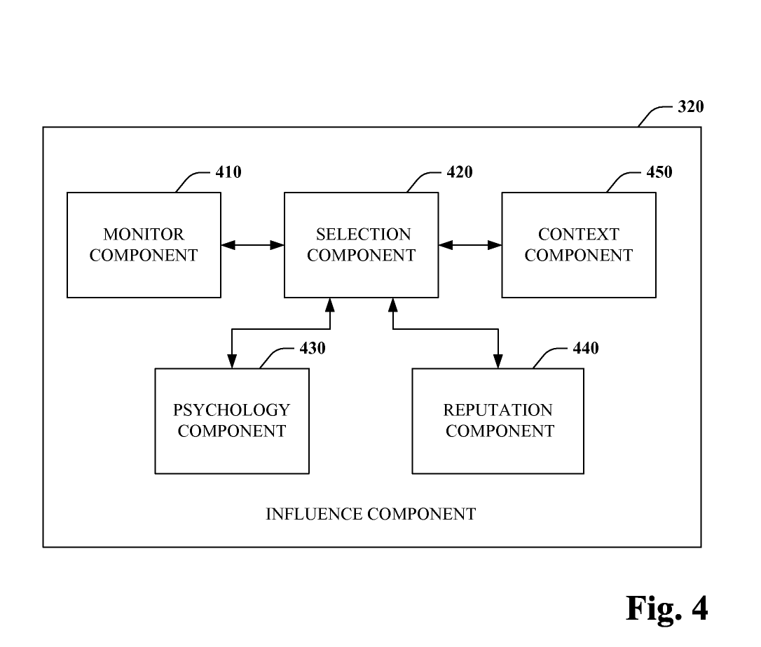

Referring to FIG. 4, an exemplary influence component 150 is illustrated in accordance with an aspect of the disclosure. Content such as digital files can have associated restrictions with respect to access and/or usage. In one instance, these restrictions can form part of the content itself as metadata, a watermark or the like. Monitor component 410 can monitor content access and/or use with respect to these restrictions and detect violations. For example, the monitor component 410 can periodically check, for instance upon access, to determine whether a user has license to access the content. Similarly, if a usage restriction indicates that a file is not to be transmitted, then a violation can be detected when the file is transmitted to another. Also note that the monitor component 410 can identify attempted violations or acts leading up to possible violations such that anticipatory action can be taken.

The monitor component 410 is communicatively coupled to selection component 420. The selection component 420 receives, retrieves or otherwise obtains or acquires information pertaining to violations or likely violations from the monitor component 410. An appropriate response thereto is then identified by the selection component 420. As illustrated, the selection component 420 can initiate a response of a particular extent from one or both of psychology component 430 and reputation component 440. The extent and type of response can be determined based on context information obtained from or provided by context component 450. Among other things, context information can pertain to a particular user such as there gender, age, ethnicity, religion and education, as well as digital content and current events.

Psychology component 430 is operable to affect emotional and/or behavior characteristics of a user to encourage compliance and deter piracy, among other things. For example, the psychology component 430 can arise a feeling of guilt in a user. In one instance, this can be accomplished by providing targeted messages (e.g., text, audio, video, multimedia . . . ) to the user. For example, a text box message can be displayed upon accessing unlicensed content that states, “Unlicensed access to this content constitutes theft.” Such messages are meant to implicitly guilt a user into acquiring the necessary rights. Messages that are more explicit can also be employed such as “In addition to being unethical, your actions are illegal. Please contact ABC Company to obtain necessary rights.” Messages can also describe the negative economic impact of piracy including the increased cost to more ethical users, lost jobs, and decreased research and development. Additionally, the messages can identify victims of theft such individuals, developers, artists and families. Pictures of such victims and also be displayed as well as the time and money expended to develop particular content. Furthermore, consequences of conviction for stealing software can be enumerated including fines, jail terms, loss of job, unable to sit for state bar exam, inability to obtain security clearance and the like. Convicted thieves can also be noted together with their sentences.

The psychology component 430 can also utilize content information from component 450 to tailor application to individual users. For instance, male users may receive different messages users than female users. In another instance, religious passages can be sited from respective user religions denouncing steeling, theft and the like. Messages can also be personalized to remove the generality associated with them. For example, “John Smith you have illegally accessed this content ten times in the last week. Clearly, you value our services. Our existence is dependent on financial support from our customers. Please obtain a license for this content.” Furthermore, the frequency and strength of message can be customized to maximize effectiveness and minimize emotional distress. Machine learning can also be utilized in this regard to infer appropriate messages based on history and context, among other things.

It be noted that the psychology component 430 is not limited to punishing or threatening to punishing “bad” behavior. Component 430 can also be employed to reward “good” behavior. In one instance, discounts can be offered for prompt compliance. Additionally or alternative, rewards can be provided for aiding distribution and/or licensing of content. For example, if a user refers a music file to a particular number of friends they can receive a free music license. Furthermore, the psychology component 430 can be specialized for particular context such as the demographics of a user. For instance, free or discounted beer for a fraternity home if everybody buys a certain song. In this manner, licensing and distribution are encouraged.

The reputation component 440 can actively affect and/or threaten to affect an individual's reputation based on actions or lack thereof. Reputation can refer to an aggregate reputation known to all or a particular group of one or more other users. By way of example, consider an instance where a first user provides a second user a file, which indicates that it should not be transmitted to others. If it is detected by the monitor component 410 that the file was transmitted, the first user can be notified thereby negatively affecting his/her opinion of the second user. Reputation can also be updated more globally. For instance, a user can have a group (e.g., social network) or online reputation metric that can be updated based on detected rights violations. In the above example, the rights violation detected by transmitting the file to others can be utilized, additionally or alternatively, to adjust the second users group and/or online reputation. It should also be appreciated that the reputation component 440 can act to improve user reputation, for instance if over time the user continually complies with license requirements and/or usage restrictions. Further, the reputation component 440 can provide messages similar to psychology component 430 upon detection that a violation may be imminent, noting, for instance, the effect on a user's reputation and/or relationship with other users.

The reputation component 440 can also be utilized more in a more positive way. For example, the can be employed to identify influential people and/or social network patterns. These people and/or patterns can subsequently be utilized to promote the system via use, word of mouth, paid advertisement or the like as well as identify ways to improve the system by taking advantage of identified trends and/or group wisdom, among other things.

Of course, many other components can be utilized alone or in combination with the psychology and reputation components 430 and 440, respectively. These additional mechanisms can influence or persuade a user to cease unauthorized use and/or obtain rights to content within attempting to make it technologically impossible or unfeasible. For example, other components (not shown) can be employed to admonish, berate, irritate and/or report or threaten report of illegal use to proper authorities.

Returning to FIG. 1, the system 100 is designed to support personal rights management/enforcement in accordance with an aspect of the disclosure. Conventionally, the similar systems are assembled to solely to support large entities such as the music or television industry or other business organizations. Such architectures are not conducive with managing individual user rights. Here, while users can store content on devices, they can also choose to store various personal content in one or more cloud store(s) 140. For example, some or all files (e.g., music, pictures, video, word processing documents, spreadsheets, presentations . . . ) associated with conventional personal computers and other computing devices can be persisted remotely in at least one cloud store 140. A group of individual content can be protected via segmentations and/or access lists; However, it may also be desirable to associate rights with particular content. This can be effectuated via rights cloud service 120.

More specifically, user identity can be authenticated utilizing identity component 130. The authenticated user can then provide and/or identify digital content (e.g., file) he/she wishes to secure with protection component 150. The user can also identify access and/or usage restriction to apply. The protection component 150 can then secure a file, for example, by encrypting all or a portion thereof. The key or keys associated with the file can be stored as well as the identities of those with rights to the key(s).

A user may attempt to interact with protected content by downloading it to a local device from a remote location or another device or simply accessing it remotely. Of course, user cannot successfully utilize the protected content without removing particular security features. To unlock a file or features thereof, a key may be needed. Hence, a user's identity can first be authenticated by the identity component 130. Subsequently, a key request list can then be checked to determine if the key should be provided to a particular authenticated identity. If so, the key can be utilized to unlock particular security functionality. If not, the protection remains in place. It should be noted that at least some of the usage restrictions could be managed by software associated with particular content alone or in conjunction with particular keys.

In this manner, users with rights can seamlessly access content while protecting it from others without rights. Furthermore, such content can be freely distributed without worries. For example, files can be distributed through anonymous ad-hoc network topologies (e.g., peer-to-peer). However, recipients need a key to access the file, distribution of which can be controlled by the file owner. It should also be appreciated that content can be marked with unprotected identifying information to enable such content to be located, categorized and/or organized, inter alia. Further yet, owner information can be exposed, for instance via unprotected metadata or electronic watermark/signature. In this case, users without access rights could determine from whom rights could be requested. For example, if one receives or retrieves a song from someone or somewhere, he/she needs to be able to determine where to go to request rights to play the song.

While protection mechanisms can be established and employed by substantially the same entity, variations are also possible. For example, means and/or mechanisms can be employed for setting up individual as well as group permissions. Further, permission and the like can be authored and/or administered separately by one entity and accessed by a different entity. In a parental control scenario, a parent may be the owner, but the child is the viewer. As per a business scenario, a business may set policy, but the employee is the owner. Other variations (e.g., permutations, combinations . . . ) will become apparent upon reading and comprehending the subject disclosure, all of which are intended to be within the scope of invention.

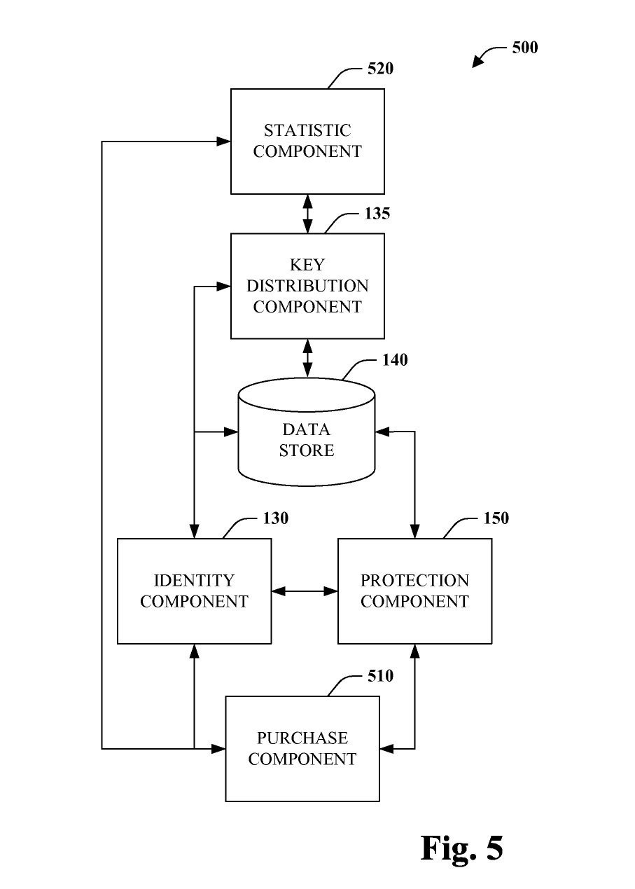

Referring to FIG. 5, a rights system 500 is illustrated that facilitates a frictionless marketplace according to an aspect of the subject disclosure. Rights system 500 can be a cloud service. Similar to the rights service 120 of FIG. 1, system 500 includes the identity component 130, key distribution component 135, data store(s) 140 and protection component 150 as previously described. In brief, the identity component 130 can distinguish between user identities by comparing provided information with information previously obtained and persisted to data store(s) 140. The protection component 130 protects content in a myriad of different ways, and key distribution component 135 can provide content access to authenticated users with rights. Additionally, system 500 includes a purchase component 510 that can collect and distribute payment. In a commercial setting, rights are sold to and purchased by users. Artists or other content owners can employ the services of the identity component 130, data store(s) 140, protection component 150 and purchase component 510 to provide secure access to licensed content. Still further, system 500 includes a statistic component 520 that can track key distribution and generate statistics regarding users and/or usage patterns. This information can be provided back to a content owner or others to utilize for marketing, sales figures and awards among other things. Additionally or alternatively, the statistics can be employed to determine fees such as those associate with the service and/or owner.

Although not limited thereto, consider, for instance, a musician or recording company that wishes to sell music. Encrypted copies of songs can be generated by the musician or company utilizing protection component 150. Rights can then be designated to any identity associated with a purchased license as indicated by purchase component 5 10. To purchase rights to a song, a user identity is first validated by the identity component 130. The purchase component 510 can then be employed by a user to receive payment for a license from the user. Subsequently, the purchase component 510 can associate a license with the song and the identity, for example in the data store(s) 140. The purchase component 510 can then credit the song artist or musician company an agreed upon fee (e.g. a portion of the license fee). This can be done upon license purchase or in a periodic bulk process and possible in conjunction with statistic component 520. Encrypted copies of the song can be freely distributed. For example, they can be downloaded, linked to and/or transmitted amongst users. Keys are then made available on demand by key distribution component 135. Hence, a user can access the song from any device anywhere as long as identity can be authenticated. For instance, users may exchange songs or other content with each other and merely purchase licenses and retrieve keys on demand. Furthermore, songs are stored on a computing device that crashes such that the downloaded songs are inaccessible. The songs can be downloaded freely again to a new device from any available means such as a website, music store or friend. Still further yet, the system 500 can provide the user with the identities of items for which they have licenses to aid in the recover process, among other things. Additionally, the system 500 and more particularly purchase component 510 can warn users if they already have rights to content to avoid, inter alia, purchasing something more than once. Further, yet suggestions could also be provided such as “if you like A, you may also like B.” This is a fundamentally different model than conventional systems that seek to control content distribution.

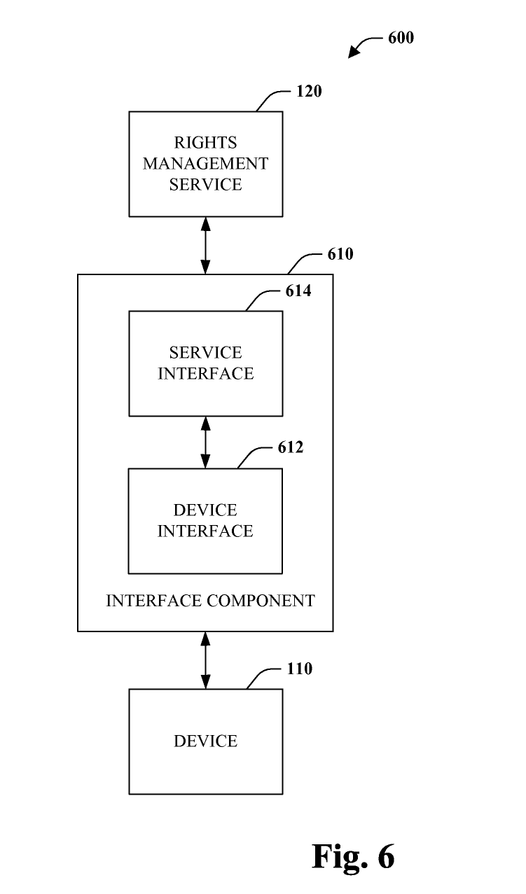

FIG. 6 depicts a system 600 to facilitate interaction with a rights service in accordance with an aspect of the disclosure. As depicted, interface component 610 is communicatively coupled to rights service 120 and one or more devices 1 10. Interface 610 enables communication between a user employing some device 110 and the rights service 120. More specifically, the interface component includes a device interface component 612 and a service interface component 614, communicatively coupled. The device interface 612 is operable to communicate with the device 1 10, while the service interface 614 is operable to communicate with the service 120. Furthermore, the device interface 612 implements service interface commands and service interface 614 implements device interface commands. Accordingly, commands issued by device 110 can be received by interface component 610 and converted to service commands via device and service interface components 612 and 614, respectively. It should be appreciated that a graphical user interface (GUI) can be associated with the interface component 612 to aid communication. Furthermore, while the interface component 612 is illustrated as being separate from both the device 110 and the service 120, it is to be appreciated that it may be embedded into the device 110 and/or the service 120.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, influence component 330 can employ machine learning to generate timely and effective messages likely to convince a user to acquire license rights while minimizing emotional distress. Further yet, the identity component can utilize machine learning with respect to users, their behaviors and the like to facilitate positive identification thereof and mitigate the risk of incorrect identification.

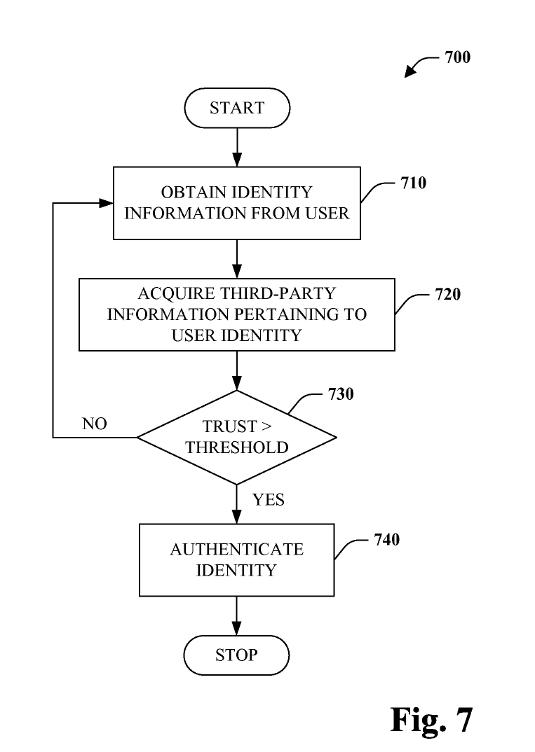

In view of the exemplary systems described supra, methodologies that may be implemented in accordance with the disclosed subject matter will be better appreciated with reference to the flow charts of FIGS. 7-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 7, a method of authenticating user identity 700 is depicted in accordance with a disclosed aspect. At reference numeral 710, identity information is obtained from a user. This information can include user name and password. Additionally or alternatively, the information can include that which identifies an individual with greater confidence including but not limited to biometric information (e.g., fingerprint, handprint, iris pattern, voice, typing pattern . . . ). At 720, third-party information can be acquired pertaining to a user's identity. A user, group or organization can provide authentication information based additional checks or observations provided thereby. For instance, an organization can issue a smartcard and pass code to a user and provide the user's identity based thereon. At numeral 730, a check is made to determine whether a trust threshold is satisfied. Various information can be associated with a trust level based on, among other things, reliability and the ease of which the information could have been hacked or associated with another individual. For example, a user name and pass code would be less trustworthy than a fingerprint scan. If the trust level is greater than a threshold then the user can be authenticated and/or authorized at 740. However, if the trust level is less than the threshold, the process can continue by re-gathering or obtaining additional information. By gathering information from multiple sources, identity can be verified with a high degree of confidence. This is significant where rights are associated with identity and available on demand.

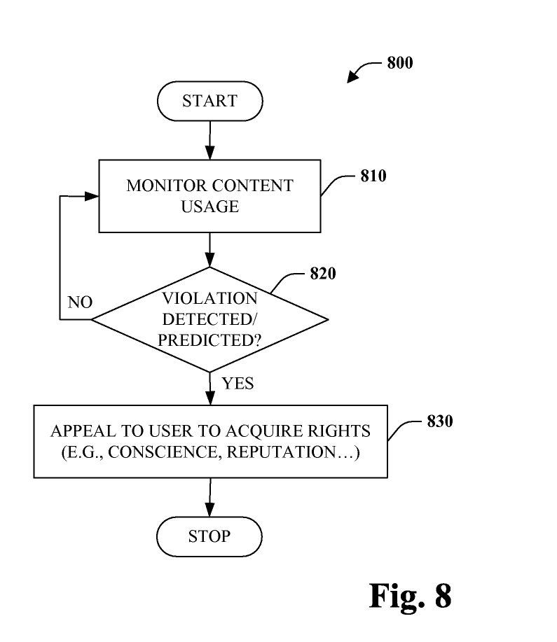

FIG. 8 depicts an additional or alternative protection methodology 800 in accordance with an aspect of the disclosure. Content need not be protected by mechanisms that utilize cryptography and the like. There are other intangibles that prevent user from utilizing content without a license. At reference 810, content usage is monitored. Based on the monitoring a determination is made at numeral 820 as to whether a violation has been detected or predicted. For example, content can be periodically pinged to determine if a user has rights to the content or unlicensed content could provide such notification. Similarly, machine learning can be employed to predict if and when unlicensed content will be utilized. If a violation has not been detected or predicted, the method 800 can proceed to numeral 810 where monitoring is continued. However, if a violation is detected or predicted, the method 800 can proceed to numeral 830. At reference numeral 830, one or more methods are employed to appeal to a user to acquire rights. User actions are influenced by a myriad of internal and external factors. Method 800 attempts to loosely protect content and/or encourage license acquisition by appealing to such intangible factors (e.g., psychological). For example, a user may not utilize content for which they do not have rights because they feel guilty or fear prosecution. Hence, a user can be made to feel guilty for stealing content and/or made aware of the consequences of such action via one or more targeted messages. Additionally or alternatively, users may not utilized content without a license if others will be informed. Accordingly, the users reputation can be negatively affected of threatened to be negatively affected, for example by informing people of such action or modifying a public or group reputation metric. Still further yet, rather than punishing or threatening punishment of user's to persuade them to acquire rights, more positive means can be employed such as improving the user's reputation and/or providing incentives

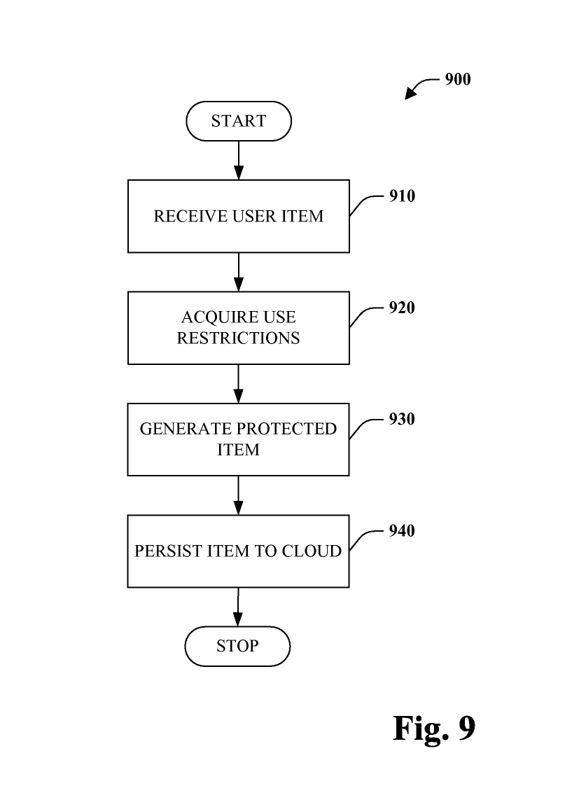

Referring to FIG. 9, a method 900 of protecting personal content is depicted in accordance with an aspect of the disclosure. At reference numeral 910, a user item is received such as a digital file or the like. Restrictions associated with the user item are received at 920. These restrictions can pertain to access and/or usage limitations. At numeral 930, a protected item is generated. This can be accomplished by applying one or more protection techniques to the item. For example, the item can be encrypted. Furthermore, during this encryption process the encrypted item, content or the like can be tagged with metadata to facilitate identification of the owner, content and/or source for acquiring rights, among other things. This protected item is then persisted to a cloud at reference 940. Subsequently, a user can seamlessly access the protected item from any network device anywhere upon satisfactory verification of identity. Furthermore, users do not need to worry if such this item is provided intentionally or accidentally to others as it protected. Only users with rights will be able to access the item and usage may still be limited.

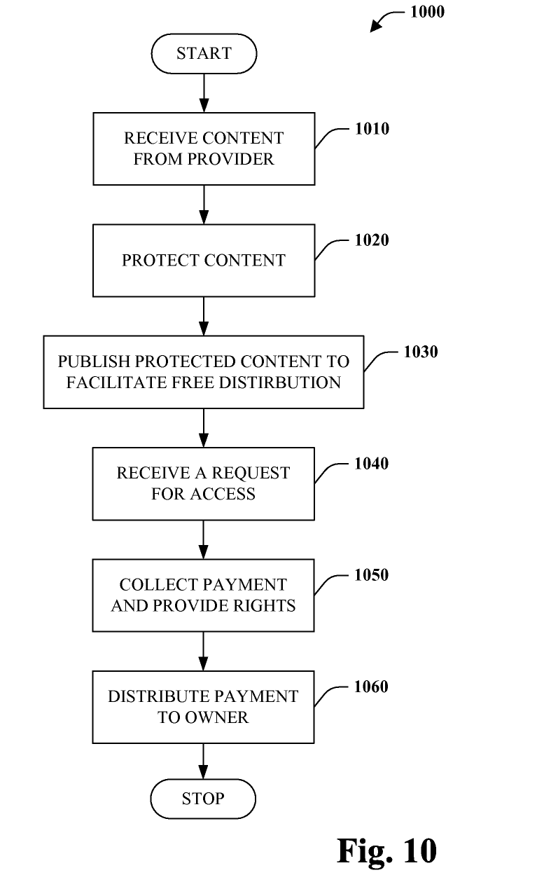

FIG. 10 a commercial distribution method 1000 is illustrated in accordance with an aspect of the disclosure. At reference numeral 1010, content is received from a provider (e.g., artist, musician, entertainment company . . . ). The content is then protected at numeral 1020. For example, this can involve encrypting the content or portions thereof such that it can only be accessed with the key utilized to encrypt the content. At reference 1030, protected content is published to in a manner to facilitate free distribution thereof The content can be copied, linked to, and/or transmitted, among other things, free of limitation. At 1040, a request is received for access to content. This can be in the form of a request for a particular key. At numeral 1050, payment is received and rights granted. Rights can be granted by associated a key for the content with the identity such that the key can be distributed upon request to unlock the protection. At reference numeral 1060, payment is distributed to the owner of the content. For example, at least a portion of the license fee can be credited to the owner.

As used herein, the terms “component,” “system,” “service” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The term “entity” is intended to include one or more individuals/users. These users may be associated formally or informally, for instance as a member of a group, organization or enterprise. Alternatively, entities and/or users can be completely unrelated.

A “cloud” is intended to refer to a collection of resources (e.g., hardware and/or software) provided and maintained by an off-site party (e.g. third party), wherein the collection of resources can be accessed by an identified user over a network (e.g., Internet, WAN . . . ). The resources provide services including, without limitation, data storage services, security services, and/or many other services or applications that are conventionally associated with personal computers and/or local servers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

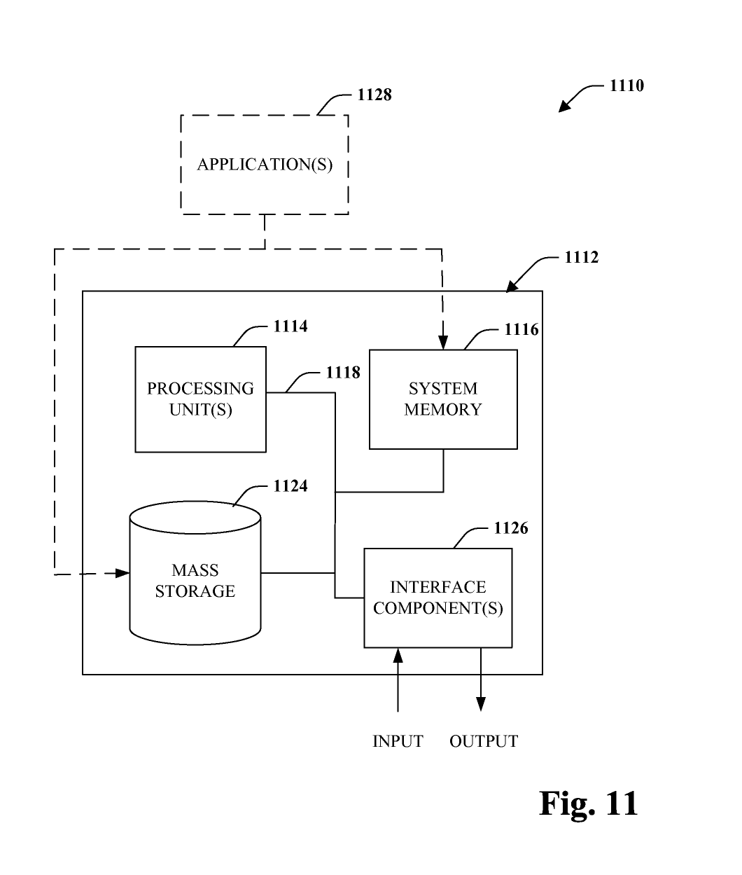

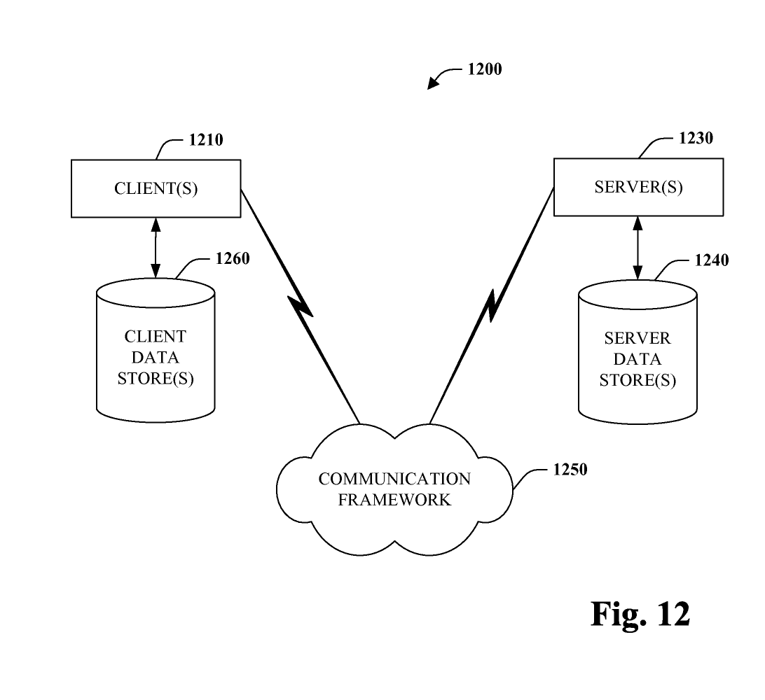

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

With reference to FIG. 11, an exemplary environment 1110 for implementing various aspects disclosed herein includes a computer 1112 (e.g., desktop, laptop, server, hand held, programmable consumer or industrial electronics . . . ). The computer 1112 includes a processing unit 1114, a system memory 1116, and a system bus 11 18. The system bus 1118 couples system components including, but not limited to, the system memory 1116 to the processing unit 11 14. The processing unit 1114 can be any of various available microprocessors. It is to be appreciated that dual microprocessors, multi-core and other multiprocessor architectures can be employed as the processing unit 11 14.

The system memory 1116 includes volatile and nonvolatile memory. The basic input/output system (BIOS), containing the basic routines to transfer information between elements within the computer 1112, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1112 also includes removable/non-removable, volatile/non-volatile computer storage media. FIG. 11 illustrates, for example, mass storage 1124. Mass storage 1124 includes, but is not limited to, devices like a magnetic or optical disk drive, floppy disk drive, flash memory or memory stick. In addition, mass storage 1124 can include storage media separately or in combination with other storage media.

FIG. 11 provides software application(s) 1128 that act as an intermediary between users and/or other computers and the basic computer resources described in suitable operating environment 1110. Such software application(s) 1128 include one or both of system and application software. System software can include an operating system, which can be stored on mass storage 1124, that acts to control and allocate resources of the computer system 1112. Application software takes advantage of the management of resources by system software through program modules and data stored on either or both of system memory 1116 and mass storage 1124.

The computer 1112 also includes one or more interface components 1126 that are communicatively coupled to the bus 1118 and facilitate interaction with the computer 1112. By way of example, the interface component 1126 can be a port (e.g., serial, parallel, PCMCIA, USB, FireWire . . . ) or an interface card (e.g., sound, video, network . . . ) or the like. The interface component 1126 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1112 to output device(s) via interface component 1126. Output devices can include displays (e.g. CRT, LCD, plasma . . . ), speakers, printers and other computers, among other things.

FIG. 12 is a schematic block diagram of a sample-computing environment 1200 with which the subject innovation can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing the aspects of the subject innovation, for example. One possible communication between a client 1210 and a server 1230 may be in the form of a data packet transmitted between two or more computer processes.

The system 1200 includes a communication framework 1250 that can be employed to facilitate communications between the client(s) 1210 and the server(s) 1230. Here, the client(s) can correspond to network computing devices and the server(s) can form at least a portion of the cloud. The client(s) 1210 are operatively connected to one or more client data store(s) 1260 that can be employed to store information local to the client(s) 1210. Similarly, the server(s) 1230 are operatively connected to one or more server data store(s) 1240 that can be employed to store information local to the servers 1230. By way of example, the one or more servers 1230 and associated data stores 1240 can form at least part of a cloud for house aspects of the subject disclosure. Further, the client(s) 1210 and related stores 1260 can correspond to client devices.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

1. A personal digital rights management system embodied on a computer readable storage medium comprising:
a component that receives computer content associated with a computer user; and
a remote rights service component that regulates access to the content based at least in part on access rights and an observed human behavioral characteristic, the access rights are designated by an authorized user or owner of the content.

2. The system of claim 1, the rights service component regulates access to the content further based in part on a user identity.

3. The system of claim 2, further comprising a component that authenticates the user identity based at least in part on user or third-party information.

4. The system of claim 1, further comprising:
a protection component that encrypts the content; and
a distribution component that distributes one or more keys that decrypt the content in accordance with the designated rights.

5. The system of claim 4, the distribution component distributes keys to authenticated identified users on-demand.

6. The system of claim 4, the distribution component provides keys to a remote user service or software employed by an authenticated user upon request.

7. The system of claim 4, the keys expire after a predetermined period of time such that it is unable to be employed to decrypt the content.

8. The system of claim 4, the encrypted content is associated with metadata that identifies from whom rights can be obtained.

9. The system of claim 1, the content is distributed through an anonymous ad-hoc network.

10. The system of claim 1, the content is persisted to a remote, network-accessible store.

11. A method of media distribution embodied on a computer readable storage medium comprising:
receiving a computer readable item;
generating an encrypted copy of the item;
authenticating a user based at least in part on an observed human behavioral characteristic;
facilitating restriction free distribution or linking to the encrypted copy; and
providing a key to decrypt the item to a service or application employed by an authenticated user on-demand.

12. The method of claim 11, further comprising receiving payment of a fee from the user for access to the item.

13. The method of claim 12, further comprising providing at least a portion of the received fee to an owner of the item.

14. The method of claim 11, further comprising verifying machine independent user identity prior to providing the key such that keys are associated with a unique user.

15. The method of claim 14, verifying user identity comprises aggregating data from third-party authentication sources and comparing the data to a threshold level of trustworthiness.

16. The method of claim 11, further comprising warning the user, if the user attempts to purchase duplicative rights to item already owned by the user.

17. The method of claim 11, further comprising encoding the encrypted item with computer-readable metadata that identifies at least one source for acquiring rights to the key.

18. The method of claim 11, further comprising tracking item usage based on key distribution.

19. A method of protecting content comprising:
monitoring access to computer readable content under protection;
inferring attempted unauthorized access to the content; and
persuading a user to acquire rights to the content by presenting a message via artificial intelligence that employs psychological reasoning based at least in part on at least one of the user's gender, age, ethnicity, religion, or education.

20. The method of claim 19, persuading the user comprises at least one of presenting a message that appeals to the user's conscience, threatening to impact a measure of the user's reputation, or providing an incentive to the user.
